(19) United States
(12) Patent Application Publication
(10) Pub. No.: US 2024/0332751 A1
(43) Pub. Date: Oct. 3, 2024

(54) SECONDARY BATTERY AND PRODUCTION METHOD FOR THE SAME

(71) Applicant: HONDA MOTOR CO., LTD., Tokyo (JP)

(72) Inventors: Toshiyuki ARIGA, Saitama (JP); Kazuki SAIMEN, Saitama (JP)

(21) Appl. No.: 18/586,557

(22) Filed: Feb. 26, 2024

(30) Foreign Application Priority Data
Mar. 29, 2023 (CN) 202310321328.2

(51) Int. Cl. H01M 50/538; H01M 10/04; H01M 50/105

(52) U.S. Cl. CPC H01M 50/538; H01M 10/0431; H01M 50/105

(57) ABSTRACT

A secondary battery according to the present invention includes: an electrode laminate having positive electrode layers, negative electrode layers, and a separator; an exterior body; a positive electrode terminal and a negative electrode terminal provided in the exterior body; a lead wire connecting between the positive electrode layers and the positive electrode terminal; and a lead wire connecting between the negative electrode layers and the negative electrode terminal. The separator has an extension portion extending outward beyond end portions of the positive electrode layers on a side connected with the positive electrode terminal. At least a part of a portion in contact with negative electrode layers on a surface of the separator on the negative electrode layer side is configured as a conductive region, and at least a part of an end portion of the extension portion on the positive electrode terminal side is configured as a nonconductive region.

This application is based on and claims the benefit of priority from Chinese Patent Application No. CN202310321328.2, filed on 29 Mar. 2023, the content of which is incorporated herein by reference.

### BACKGROUND OF THE INVENTION

### Field of the Invention

The present invention relates to a secondary battery and a production method for the same.

### Related Art

In recent years, research and development on secondary batteries that contribute to energy efficiency have been conducted to allow more people to surely access an affordable, reliable, sustainable, and advanced energy. To improve energy densities of secondary batteries, secondary batteries having a laminated structure with multiple positive electrode layers and negative electrode layers alternately overlaid have been investigated. For the second batteries having this laminated structure, it has been investigated that an elongated separator is folded in a zigzag shape and positive electrode layers and negative electrode layers are alternately overlaid in the folded portions, e.g. for the purpose of suppressing displacement of the positive electrode layers and negative electrode layers (Patent Documents 1 and 2).
Patent Document 1: PCT International Publication No. WO2020/003846
Patent Document 2: PCT International Publication No. WO2020/003847

### SUMMARY OF THE INVENTION

Incidentally, in the technologies regarding secondary batteries, there is a task to achieve a higher capacity. The practical application of lithium metal secondary batteries made of a metallic lithium as a negative electrode active material for the higher capacity of secondary batteries has been desired. However, in a lithium metal secondary battery, a thickness of a negative electrode layer significantly changes due to charge and discharge. Thus, in a lithium metal secondary battery having a laminated structure with multiple positive electrode layers and negative electrode layers alternately overlaid, change in a thickness of a negative electrode layers due to charge and discharge is likely to displace the negative electrode layers and positive electrode layers.

When a lithium metal secondary battery is repeatedly charged and discharged, an SEI layer (solid electrolyte intermediate phase) accumulates on an interface between a current collector and lithium in the negative electrode layer, and a lithium dendrite is easily generated during charging. Once the lithium dendrite is generated, the lithium dendrite may penetrate a separator, resulting in a short circuit between the positive electrode layers and the negative electrode layers. Furthermore, once the lithium dendrite is generated, a density of a metallic lithium layer (negative electrode active material layer) deposited on the negative electrode current collector may decrease, resulting in excessive expansion of the lithium secondary battery during charging.

According to the inventor's investigation, a laminate with a conductive layer laminated on a surface of a porous film is used as a separator, and the conductive layer is placed on the negative electrode layer side, so that it is possible to suppress a short circuit due to the dendrite and decrease in a density of the active material layer of the negative electrode layers during charging in some cases. However, in a second battery including a separator having a conductive layer on its surface on a negative electrode layer side, the conductive layer may come into contact with positive electrode layers or a positive electrode lead wire that connects between the positive electrode layers and a positive electrode terminal, resulting in a short circuit between the positive electrode layers and negative electrode layers.

The present invention has been made in view of the above-mentioned circumstances, and an object of the present invention is to provide a secondary battery with a conductive layer that is less likely to come into contact with positive electrode layers or a positive electrode lead wire even when a thickness of the negative electrode layers is significantly changed due to charge and discharge and a separator has a conductive layer on a negative electrode layer side, and with the positive and negative electrode layers that are less likely to cause a short circuit, and provide a production method therefor. Consequently, the objects contribute to improvement of energy efficiency.

The present inventors have found that it is effective that, for solving the above-mentioned problems, an extension portion extending outward beyond end portions of positive electrode layers on a side connected with a positive electrode terminal are provided on a separator, at least a part of a portion in contact with negative electrode layers is configured as a conductive region with a conductive layer, and at least a part of the end portion of the extension portion on the positive electrode terminal side is configured as a nonconductive region without the conductive layer. This finding has completed the present invention. Thus, the present invention provides the following aspects.

(1) A secondary battery including an electrode laminate having positive electrode layers, negative electrode layers, and a separator placed between the positive electrode layers and the negative electrode layers, an electrolytic solution, an exterior body accommodating the electrode laminate and the electrolytic solution, a positive electrode terminal and a negative electrode terminal provided in the exterior body, a positive electrode lead wire electrically connecting between the positive electrode layers and the positive electrode terminal, and a negative electrode lead wire electrically connecting between the negative electrode layers and the negative electrode terminal; the separator having an extension portion extending outward beyond end portions of the positive electrode layers on a side connected with the positive electrode terminal; and at least a part of a portion in contact with the negative electrode layers on a surface of the separator on the negative electrode layer side being configured as a conductive region with a conductive layer, and at least a part of an end portion of the extension portion on the positive electrode terminal side being configured as a nonconductive region without the conductive layer.

In the secondary battery according to (1), since, in the separator, at least a part of the extension portion extending outward beyond the end portions of the positive electrode layers on the side connected with the positive electrode terminal is configured as the nonconductive region, the conductive layer provided on a part of the separator in contact with the negative electrode layers is less likely to come into contact with the positive electrode layers or the positive electrode lead wire even when a thickness of the negative electrode layers is significantly changed due to charge and discharge. Thus, a short circuit between the positive electrode layers and the negative electrode layers is less likely to occur.

(2) The secondary battery according to (1), in which the separator is an elongated separator including an elongated insulating porous film, the conductive region provided on one surface of the elongated insulating porous film, and the nonconductive region, the conductive region being extended along a length direction of the elongated insulating porous film, the nonconductive region being placed on at least one width-directional end portion of the elongated insulating porous film, and first folds folded along the length direction such that their surfaces on the elongated insulating porous film side are inside and second folds folded along the length direction such that their surfaces on a side of the conductive region and the nonconductive region are inside, being alternately overlaid; the positive electrode layers are inserted into the first folds and located at a position where the nonconductive region is the extension portion, and the negative electrode layers are inserted into the second folds and located at a position in contact with the conductive region; the positive electrode terminal is electrically connected with end portions of the positive electrode layers on the nonconductive region side; and the negative electrode terminal is electrically connected with end portions of the negative electrode layers on an opposite side to the nonconductive region side.

In the secondary battery according to (2), the separator is an elongated separator, and the positive electrode layers and negative electrode layers are respectively located in the first folds and second folds alternately formed, so that the positive and negative electrode layers are less likely to be displaced. A belt-like conductive layer is formed along the length direction of the elongated separator, and a length of the conductive layer in the length direction is longer than that of the negative electrode layers, so that the effect of the conductive layer can be reliably obtained. Furthermore, the nonconductive region of the elongated separator is the extension portion, so that the conductive layer is less likely to come into contact with the positive electrode layers or the positive electrode lead wire.

(3) The secondary battery according to (1) or (2), in which an end portion of the conductive region on the positive electrode terminal side is located at the same position as or inside of the end portions of the negative electrode layers on the positive electrode terminal side.

In the secondary battery according to (3), since the end portion of the extension portion is configured as the nonconductive region, the conductive layer is less likely to come into contact with the positive electrode layers or the positive electrode lead wire.

(4) The secondary battery according to any one of (1) to (3), in which the nonconductive region is located only on the end portion of the separator on the positive electrode terminal side.

In the secondary battery according to (4), the region other than the end portion of the extension portion is configured as the conductive region, thereby the contact area between the conductive layer and the negative electrode layers is increased, and therefore it is possible to suppress a short circuit due to dendrites and decrease in a density of an active material layer of the negative electrode layers during charging.

(5) The secondary battery according to any one of (1) to (4), in which a negative electrode active material is metallic lithium.

In the secondary battery according to (5), since the negative electrode active material is metallic lithium, a higher capacity can be achieved.

(6) A production method for the secondary battery, including:
preparing an elongated separator by folding, in a zigzag shape, an elongated laminated sheet including an elongated insulating porous film, a conductive region with a conductive layer placed on one surface of the elongated insulating porous film, and a nonconductive region without the conductive layer, the conductive region being extended along a length direction of the elongated insulating porous film, and the nonconductive region being placed on at least one width-directional end portion of the elongated insulating porous film, in such a way that first folds folded along the length direction such that their surfaces on the elongated insulating porous film side are inside and second folds folded along the length direction such that their surfaces on a side of the conductive region and the nonconductive region are inside are alternately overlaid;
placing positive electrode layers and negative electrode layers in the first folds and the second folds respectively so as to be opposed to each other; and
connecting a positive electrode terminal to end portions of the positive electrode layers on the nonconductive region side via a positive electrode lead wire, and connecting a negative electrode terminal to end portions of the negative electrode layers on the opposite side to a side connected with the positive electrode terminal via a negative electrode lead wire.

In the production method for the secondary battery according to (6), since the positive electrode terminal is connected to the end portions of the positive electrode layers on the nonconductive region side via the positive electrode lead wire, a secondary battery with the extension portion extending to the end portions of the positive electrode layers on a side connected with the positive electrode terminal can be advantageously produced for industrial applications. Since the positive electrode layers and the negative electrode layers are placed in the first folds and the second folds respectively, of the elongated separator, the positive electrode layers and the negative electrode layers in the obtained secondary battery are less likely to be displaced. Furthermore, the belt-like conductive layer is formed along the length direction of the elongated separator, and a length of the conductive layer in the length direction is larger than of the negative electrode layers, so that the obtained secondary battery can reliably exhibit effects of the conductive layer.

The present invention makes it possible to provide a secondary battery with a conductive layer that is less likely to come into contact with positive electrode layers or a positive electrode lead wire even when a thickness of the negative electrode layers is significantly changed due to charge and discharge and a separator having a conductive layer on a negative electrode layer side is used, and with the positive and negative electrode layers that are less likely to cause a short circuit, and provide a production method therefor.

### BRIEF DESCRIPTION OF THE DRAWINGS

FIG. 1 is a perspective view of a secondary battery according to an embodiment of the present invention;

FIG. 2 is a sectional view taken along line II-II in FIG. 1;

FIG. 3 is a sectional view taken along line III-III in

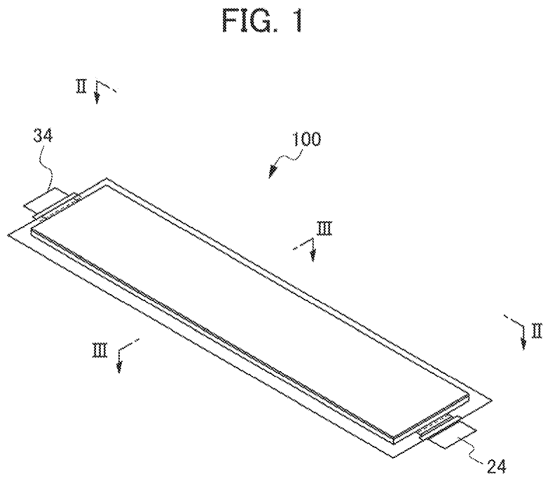

FIG. 1;

FIG. 4 is a plane view of a separator for the secondary battery according to an embodiment of the present invention; and

FIG. 5 is a sectional view taken along line V-V in FIG. 4.

### DETAILED DESCRIPTION OF THE INVENTION

The embodiments of the present invention will be explained below with reference to the figures. However, the following embodiments are intended to merely illustrate the present invention, and the present invention is not limited to the following embodiments.

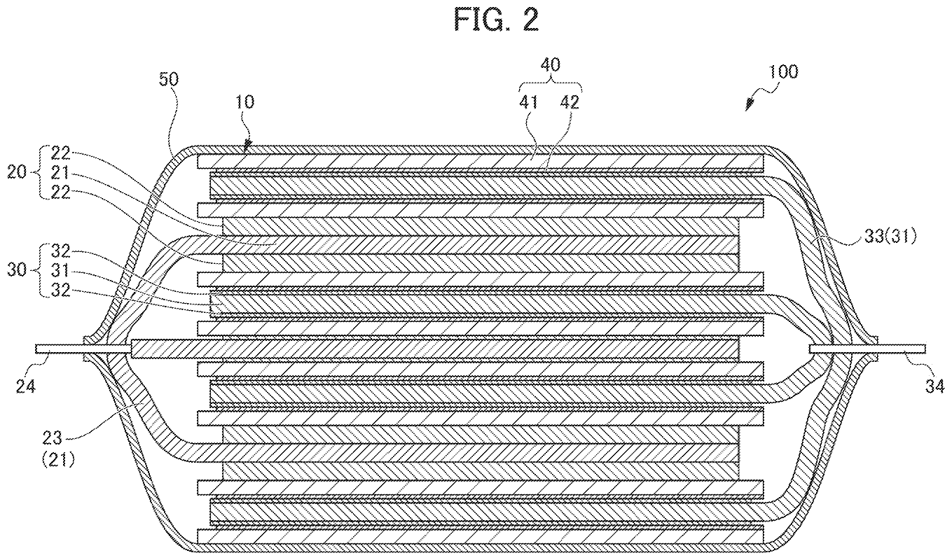

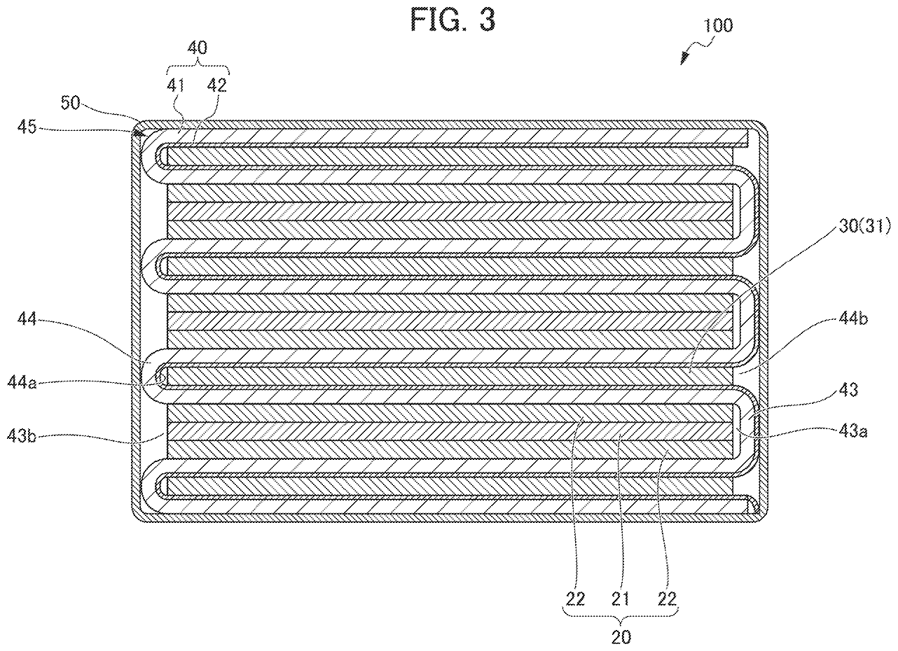

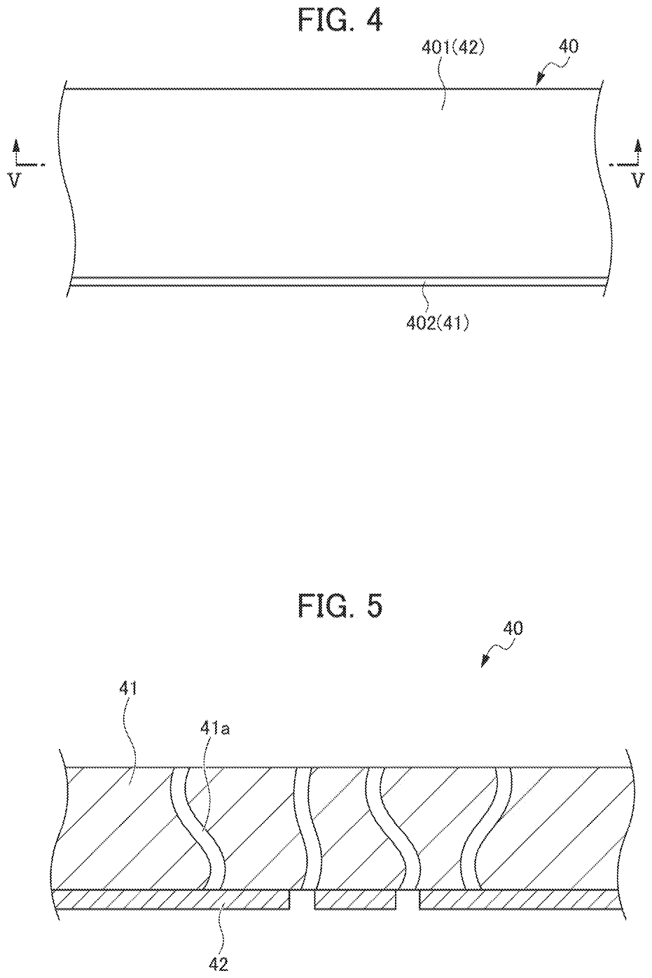

FIG. 1 is a perspective view of a secondary battery according to an embodiment of the present invention. FIG. 2 is a sectional view taken along line II-II in FIG. 1, and FIG. 3 is a sectional view taken along line III-III in FIG. 1. FIG. 4 is a plane view of a separator for the secondary battery according to an embodiment of the present invention. FIG. 5 is a sectional view taken along line V-V in FIG. 4.

A secondary battery 100 according to this embodiment includes an electrode laminate 10 having positive electrode layers 20, negative electrode layers 30, and an elongated separator 40 placed between the positive electrode layers 20 and the negative electrode layers 30; an electrolytic solution (not illustrated); and an exterior body accommodating the electrode laminate 10 and the electrolytic solution. Each positive electrode layer 20 includes a positive electrode current collector 21 and positive electrode active material layers 22 laminated on both sides of the positive electrode current collector 21. Each negative electrode layer 30 includes a negative electrode current collector 31 and lithium foils 32 laminated on both sides of the negative electrode current collector 31. The secondary battery 100 is a lithium metal secondary battery. The lithium metal secondary battery is a secondary battery made of metallic lithium as the negative electrode active material, in which, lithium is released from the positive electrode active material layers 22 during charging, and lithium is deposited on the surfaces of the lithium foils 32 to generate metallic lithium layers. Thereby, a thickness of the negative electrode layers 30 increases during charging. On the other hand, during discharging, lithium is released from the metallic lithium layers and occluded into the positive electrode active material layers 22. Thereby, the thickness of the negative electrode layers 30 decreases during discharging. Thus, the thickness of the negative electrode layers 30 is significantly changed due to charge and discharge. The secondary battery 100 illustrated in FIG. 1 to FIG. 3 is in a discharging state. As for widths, the elongated separator 40 is the widest, the negative electrode layers 30 are the next widest, and the positive electrode layers 20 are the narrowest, as illustrated in FIG. 2.

The secondary battery 100 further includes a positive electrode terminal 24 and a negative electrode terminal 34 that are placed in the exterior body 50, a positive electrode lead wire 23 electrically connecting between the positive electrode layers 20 (positive electrode current collector 21) and the positive electrode terminal 24, and a negative electrode lead wire 33 electrically connecting between the negative electrode layers 30 (negative electrode current collector 31) and the negative electrode terminal 34. A part of the positive electrode terminal 24 and a part of the negative electrode terminal 34 are exposed to the outside. The positive electrode terminal 24 is placed along a width direction of the elongated separator 40 (a direction perpendicular to the length direction of the elongated separator 40), and the negative electrode terminal 34 is placed so as to be opposed to the positive electrode terminal 24 via the electrode laminate 10 therebetween.

The elongated separator 40 has an extension portion 40a extending outward beyond the end portions of the positive electrode layers 20 on the side connected with the positive electrode terminal 24. An extended length of the extension portion 40a varies depending on a thickness of the positive electrode layers 20, a size of the positive electrode lead wire 23, a thickness of a conductive layer 42, or the like, and is e.g. no less than a thickness of the positive electrode active material layer 22. If the width of the positive electrode layers 20 is larger than the width of the negative electrode layers 30, the extension portion 40a may extend beyond the end portions of the negative electrode layers 30.

At least a part of the portion in contact with the negative electrode layers 30 on the surface of the elongated separator 40 on the negative electrode layer 30 side is configured as a conductive region 401 with a conductive layer 42, and at least a part of the end portion of the extension portion 40a on the positive electrode terminal side is configured as a nonconductive region 402 without the conductive layer 42. The conductive layer 42 may have a width (length in a direction perpendicular to the length direction of the elongated separator 40) larger than a width of the positive electrode layers 20, and equal to or not larger than a width of the negative electrode layers 30. As for a width of the conductive layer 42, the end portion of the conductive layer 42 (conductive region 401) on the negative electrode terminal 34 side may extend beyond the negative electrode layers 30 and may extend to the end portion of the elongated separator 40. The end portion of the conductive layer 42 on the positive electrode terminal 24 side may be located at the same position as or inside of the end portions of the negative electrode layers 30 on the positive electrode terminal 24 side. In this embodiment, the end portion of the conductive layer 42 on the positive electrode terminal 24 side is inside of the end portions of the negative electrode layers 30 on the positive electrode terminal 24 side. The nonconductive region 402 may be placed only on the end portion of the elongated separator 40 on the positive electrode terminal 24 side. Preferably, the nonconductive region has a width larger than at least a thickness of the positive electrode active material layer 22.

The elongated separator 40 includes an elongated insulating porous film 41, the conductive region 401 placed on the surface of the elongated insulating porous film 41 on the negative electrode layer 30 side, and the nonconductive region 402 (see FIG. 4). The conductive region 401 has a belt-like conductive layer 42 provided along the length direction of the elongated insulating porous film 41. The nonconductive region 402 has no conductive layer 42. At least one width-directional end portion of the elongated insulating porous film 41 is configured as the non-conductive region 402. In this embodiment, the nonconductive region 402 is placed on one width-directional end portion of the elongated insulating porous film 41. The elongated separator 40 is formed such that first folds 43 and second folds 44 are alternately overlaid. The first folds 43 are folded along the length direction such that their surfaces on the elongated insulating porous film 41 side are inside. Each first fold 43 has a fold end 43a, and an opening 43b located on the opposite side to the end 43a. The second folds 44 are folded along the length direction such that their surfaces on the side of the conductive region 401 and the nonconductive region 402 are inside. Each second fold 44 has a fold end 44a and an opening 44b located on the opposite side to the end 44a.

The positive electrode layers 20 and the negative electrode layers 30 are placed in the first folds 43 and the second folds 44 respectively so as to be opposed to each other. The positive electrode layers 20 are in contact with the elongated insulating porous film 41 of the elongated separator 40, and the negative electrode layers 30 are in contact with the conductive layer 42 of the elongated separator 40. The positive electrode terminal 24 is connected to the end portions of the positive electrode layers 20 (positive electrode current collector 21) on the nonconductive region 402 side. Thereby, the nonconductive region 402 of the elongated separator 40 serves as the extension portion 40a. The negative electrode terminal 34 is connected to the end portions of the negative electrode layers 30 (negative electrode current collector 31) on the opposite side to the side connected with the positive electrode terminal 24. The end portions of the positive electrode layers 20 on the opposite side to the side connected with the positive electrode terminal 24 (side where the negative electrode layers 30 are connected with the negative electrode terminal 34) may be located inside of the end portions of the negative electrode layers 30.

The material for the positive electrode current collector 21 is not particularly limited and can be e.g. aluminum. The material for the positive electrode lead wire 23 may be the same as or different from that for the positive electrode current collector 21. The positive electrode lead wire 23 may be integrally connected with the positive electrode current collector 21. In this embodiment, the positive electrode lead wire 23 is formed by extending the positive electrode current collector 21 and integrally connected with the positive electrode current collector 21. The material for the positive electrode terminal 24 may be the same as or different from that for the positive electrode lead wire 23. The positive electrode terminal 24 may be integrally connected with the positive electrode lead wire 23. In this embodiment, the positive electrode terminal 24 and the positive electrode lead wire 23 are individually separate components and electrically connected to each other.

The positive electrode active material layer 22 includes a positive electrode active material. Examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), heteroelement-substituted Li—Mn spinel represented by Li₁₊ₓMn_{2-x-y}M_{y}O₄ (x+y=2, M is at least one selected from Al, Mg, Co, Fe, Ni, and Zn), lithium titanate (oxides containing Li and Ti), and metallic lithium phosphate (LiMPO₄, M is at least one selected from Fe, Mn, Co, and Ni). The positive electrode active material layer 22 may contain various additives as materials for the positive electrode active material layer, such as binders and conductive assistants.

The material for the negative electrode current collector 31 is not particularly limited and can be e.g. copper. The material for the negative electrode lead wire 33 may be the same as or different from that for the negative electrode current collector 31. The negative electrode lead wire 33 may be integrally connected with the negative electrode current collector 31. In this embodiment, the negative electrode lead wire 33 is formed by extending the negative electrode current collector 31 and integrally connected with the negative electrode current collector 31. The material for the negative electrode terminal 34 may be the same as or different from that for the negative electrode lead wire 33. The negative electrode terminal 34 may be integrally connected with the negative electrode lead wire 33. In this embodiment, the negative electrode terminal 34 and the negative electrode lead wire 33 are individually separate components and electrically connected to each other.

As the elongated insulating porous film 41 of the elongated separator 40, a known film used as a separator for secondary batteries can be used, such as a porous sheet and a non-woven sheet. Examples of the material for the porous sheet include polyolefin such as polyethylene and polypropylene, aramid, polyimide, and fluororesin. Examples of the material for the nonwoven sheet include a glass fiber and a cellulose fiber. A thickness of the elongated insulating porous film 41 is, but not particularly limited to, preferably 10 μm or more from the viewpoint of blocking lithium metal dendrites, and preferably 15 μm or less from the viewpoint of reducing the resistance in the battery. The thickness of the elongated insulating porous film 41 is more preferably within a range of 10 to 12 μm. An air permeability of the elongated insulating porous film 41 is, but not particularly limited to, preferably 200 sec/100 mL or lower, more preferably 150 sec/100 mL or lower from the viewpoint of reducing the resistance in the battery. A porosity of the elongated insulating porous film 41 is, but not particularly limited to, preferably within a range of 40 to 60% from the viewpoint of uniform diffusion of lithium in the elongated separator 40 and strength of the elongated separator 40.

The conductive layer 42 of the elongated separator 40 need not be laminated over the entire conductive region 401. The conductive layer 42 may be laminated so as to cover some of pore portions 41a of the elongated insulating porous film 41 in the conductive region 401, as illustrated in FIG. 5. The conductive layer 42 has an electrical conductivity within a range of 1.0×10¹ to 1.0×10⁵ S/cm without particular limitation. If the conductive layer 42 has an electrical conductivity of 1.0×10¹ S/cm or higher, lithium can be deposited on the surface of the conductive layer 42, and lithium dendrites can be prevented from growing on the positive electrode layer 20 side to cause a short circuit. If the conductive layer 42 has an electrical conductivity of 1.0×10⁵ S/cm or lower, lithium can be uniformly deposited on the surface of the conductive layer 42.

The conductive layer 42 is in electrical contact with either the negative electrode layers 30 or metallic lithium deposited on the negative electrode layers 30 in both discharged and charged states. Thereby, potentials of the conductive layer 42 and the negative electrode current collector 31 are the same, and therefore lithium can be more evenly deposited between the conductive layer 42 of the elongated separator 40 and the lithium foil 32.

The conductive layer 42 may have an electrical conductivity lower than that of the negative electrode current collector 31, i.e. the negative electrode current collector 31 may have an electrical conductivity higher than that of the conductive layer 42. When the negative electrode current collector 31 has an electrical conductivity higher than that of the conductive layer 42, lithium can be prevented from being concentratively deposited on the elongated insulating porous film 41 side of the conductive layer 42, and damage of the conductive layer 42 through shape change due to concentrated deposition of lithium can be suppressed. The conductive layer 42 may have tenth to one-hundredth the electrical conductivity of the negative electrode current collector 31.

A peel strength of the conductive layer 42 from the insulating porous film 41 is, but not particularly limited to, preferably 10 N/m or higher, more preferably 30 N/m or higher. When the peel strength of the conductive layer 42 is as high as the above value, the conductive layer 42 stably acts for a long period of time, resulting in a longer charge and discharge cycle life.

The conductive layer 42 may have a surface resistivity of 200 Ω/cm² or lower.

The conductive layer 42 may have a thickness within a range of 0.01 to 5 μm. If the conductive layer 42 has a thickness of 0.01 μm or more, the aforementioned effects of the conductive layer 42 can be exhibited. If the conductive layer 42 has a thickness of 5 μm or less, reduction in the energy density due to the conductive layer 42 can be suppressed.

Examples of the material for the conductive layer 42 include conductive materials such as metals and carbon nanotubes (CNT). Examples of the metals include Cu, Zn, Ti, and Sn. These conductive materials may be used alone or in combination of two or more types.

Examples of a coating method for forming the conductive layer 42 on the elongated insulating porous film 41 include, but are not limited to, a sputtering method and an application method. Examples of the sputtering method include a direct current (DC) sputtering method and a radio frequency (RF) sputtering method. In the application method, a coating liquid with the material for the conductive layer 42 being dispersed is applied on the surface of the elongated insulating porous film 41 and dried.

The electrolytic solution contains an organic solvent and an electrolyte. Examples of the organic solvent include cyclic carbonates, chain carbonates, cyclic ethers, chain ethers, hydrofluoroethers, aromatic ethers, sulfones, cyclic esters, chain carboxylic acid esters, and nitriles. Examples of the cyclic carbonates include ethylene carbonate, propylene carbonate, vinylene carbonate, and fluoroethylene carbonate. Examples of the chain carbonates include dimethyl carbonate, diethyl carbonate, and ethyl methyl carbonate. Examples of the cyclic ethers include tetrahydrofuran, 2-methyltetrahydrofuran, tetrahydropyran, 1,3-dioxolan, and 4-methyl-1,3-dioxolan. Examples of the chain ethers include 1,2-dimethoxyethane, 1,2-diethoxyethane, ethoxymethoxyethane, and diethyl ether. Examples of the hydrofluoroethers include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, and 1,2-bis(1,1,2,2-tetrafluoroethoxy) ethane. Examples of the aromatic ethers include anisole. Examples of the sulfones include sulfolane and methylsulfolane. Examples of the cyclic esters include γ-butyrolactone. Examples of the chain carboxylic acid esters include acetic acid ester, butyric acid ester, and propionic acid ester. Examples of the nitriles include acetonitrile and propionitrile. The organic solvents may be used alone or in combination of two or more types.

The electrolyte is a source of lithium ions as a charge transfer medium and contains lithium salts. Examples of the lithium salts include LiPF₆, LiBF₄, LiC₁O₄, LiAsF₆, LiCF₃SO₃, LiC(CF₃SO₂)₃, LIN(CF₃SO₂)₂(LiTFSI), LIN(FSO₂)₂(LiFSI), and LiBC₄O₈. The lithium salts may be used alone or in combination of two or more types. The concentration of the electrolyte is e.g. within a range of 1.5 to 4.0 mol/L.

The exterior body 50 is configured to be expandable and contractable along with changes in the thickness of the electrode laminate 10 (in particular, changes in the thickness of the negative electrode layers 30) due to charge and discharge. Examples of the material for the exterior body 50 include a laminate film. Examples of the laminate film include a three-layer laminated film including an inner resin layer, a metal layer, and an outer resin layer laminated in this order from the inside. Examples of the material for the inner and outer resin layers include thermoplastic resins such as polyethylene terephthalate (PET), polyamide (nylon), and polypropylene (PP). Examples of the material for the metal layer include aluminum.

The secondary battery 100 according to this embodiment can be produced by a method including e.g. an elongated separator-preparing step, an electrode layer-placing step, a terminal-connecting step, an exterior body accommodation step, and a sealing step.

In the elongated separator-preparing step, the elongated separator 40 with the first folds 43 and the second folds 44 alternately overlaid is prepared. The elongated separator can be prepared by folding, in a zigzag shape, the elongated laminated sheet including the conductive region 401 having the elongated insulating porous film 41 and the conductive layer 42 placed on one surface of the elongated insulating porous film 41, and the nonconductive region 402 without the conductive layer 42, the conductive region 401 being extended along the length direction of the elongated insulating porous film 41, and the nonconductive region 402 being placed at least one width-directional end portion of the elongated insulating porous film 41.

In the electrode layer-placing step, the positive electrode layers 20 and the negative electrode layers 30 are placed in the first folds 43 and the second folds 44 respectively so as to be opposed to each other. This step makes it possible to obtain the electrode laminate 10. The positive electrode layers 20 can be placed by inserting the positive electrode layers 20 into the first folds 43 from the openings 43b of the first folds 43. The negative electrode layers 30 can be placed by inserting the negative electrode layers 30 into the second folds 44 from the openings 44b of the second folds 44. The elongated separator-preparing step and the electrode layer-placing step may be simultaneously proceeded in parallel. For example, a manipulation may be performed, in which the positive electrode layers 20 are placed on the surface of the elongated laminated sheet on the elongated insulating porous film 41 side, then the elongated laminated sheet is folded along the length direction such that its surface on the elongated insulating porous film 41 side is inside, subsequently the negative electrode layers 30 are placed on the surface of the elongated laminated sheet on the conductive layer 42 side, then the elongated laminated sheet is folded along the length direction such that its surface on the conductive layer 42 side is inside.

In the terminal-connecting step, the positive electrode terminal 24 is connected to the end portions of the positive electrode layers 20 (positive electrode current collector 21) of the electrode laminate 10 via the positive electrode lead wire 23, and the negative electrode terminal 34 is connected to the end portions of the negative electrode layers 30 (negative electrode current collector 31) via the negative electrode lead wire 33. The positive electrode terminal 24 is connected to the end portions of the positive electrode layers 20 on the nonconductive region 402 side of the elongated separator 40. The negative electrode terminal 34 is connected to the end portions of the negative electrode layers 30 on the opposite side to the side connected with the positive electrode terminal 24.

In the exterior body accommodation step, the electrode laminate 10 connected with the positive electrode terminal 24 and the negative electrode terminal 34 and the electrolytic solution (not illustrated) are accommodated in the exterior body 50 such that a part of the positive electrode terminal 24 and a part of the negative electrode terminal 34 are exposed to the outside. In the sealing step, the exterior body 50 accommodating the electrode laminate 10 connected with the positive electrode terminal 24 and the negative electrode terminal 34 and the electrolytic solution is sealed.

In the secondary battery 100 according to this embodiment configured as described above, since the elongated separator 40 has an extension portion 40a extending outward beyond the end portions of the positive electrode layers 20 on the side connected with the positive electrode terminal 24, the conductive layer 42 provided on a part of the elongated separator 40 in contact with the negative electrode layers 30 is less likely to come into contact with the positive electrode layers 20 or the positive electrode lead wire 23 even when a thickness of the negative electrode layers 30 is significantly changed due to charge and discharge. Thus, a short circuit between the positive electrode layers 20 and the negative electrode layers 30 is less likely to occur.

In the secondary battery 100 according to this embodiment, the elongated separator 40 is formed such that the first folds 43 and the second folds 44 are alternately overlaid, and the positive electrode layers 20 are located in the first folds 43, and the negative electrode layers 30 are located in the second folds 44, so that the positive electrode layers 20 and the negative electrode layers 30 are less likely to be displaced. The end portion of the conductive region 401 on the positive electrode terminal 24 side is inside of the end portions of the negative electrode layers 30 on the positive electrode terminal 24 side, and the end portion of the extension portion 40a is configured as the nonconductive region 402, so that the conductive layer 42 is even less likely to come into contact with the positive electrode layers 20 or the positive electrode lead wire 23. Furthermore, the nonconductive region 402 is located only on the end portion of the elongated separator 40 on the positive electrode terminal 24 side, and a region other than the end portion of the extension portion 40a is the conductive region 401, a contact area between the conductive layer 42 and the negative electrode layers 30 is increased, and therefore it is possible to suppress a short circuit due to dendrites and decrease in the density of the active material layer of the negative electrode layers during charging.

In the secondary battery 100 according to this embodiment, since the end portions of the positive electrode layers 20 on the opposite side to the side connected with the positive electrode terminal 24 (side where the negative electrode layers 30 are connected with the negative electrode terminal 34) are inside of the end portion of the elongated separator 40, the end portions of the positive electrode layers 20 on the opposite side to the side connected with the positive electrode terminal 24 are even less likely to come into contact with the conductive layer 42 of the elongated separator 40.

The production method for the secondary battery 100 according to this embodiment makes it possible to advantageously produce the secondary battery 100 for industrial applications.

Although the preferable embodiments of the present invention have been described above, the present invention is not limited to the above embodiments and can be modified as appropriate. In the secondary battery 100 according to this embodiment, the elongated separator 40 is used, but the separator is not limited to this separator 40. Each separator sheet may be interposed between the multiple positive and negative electrode layers 20 and 30. In this case, an extension portion extending outward beyond the end portions of the positive electrode layers on the side in contact with the positive electrode terminal is provided on each separator sheet, at least a part of the portion in contact with the negative electrode layers on the surface of the separator sheet on the negative electrode layer side is configured as a conductive region with the conductive layer, and at least a part of the end portion of the extension portion on the positive electrode terminal side is configured as the nonconductive region without the conductive layer.

In the secondary battery 100 according to this embodiment, the negative electrode layers 30 include the metallic lithium layer deposited as the negative electrode active material layer during charging, but the negative electrode active material layer is not limited to this metallic lithium layer. A layer including a negative electrode active material that occludes lithium during charging and releases lithium during discharging may be used as the negative electrode active material layer. Examples of the negative electrode active material include lithium transition metal oxides such as lithium titanate, transition metal oxides such as TiO₂, Nb₂O₃, and WO₃, SiO, metal sulfides, metal nitrides, as well as carbon materials such as artificial black lead, natural black lead, graphite, soft carbon, and hard carbon. As the negative electrode active material, a metal that forms an alloy together with lithium can be used. Examples of the metal that forms an alloy together with lithium include Mg, Si, Au, Ag, In, Ge, Sn, Pb, Al, and Zn.

The elongated separator 40 has an extension portion extending in the length direction, and the extension portion may be wound around the outer surface of the electrode laminate 10 such that its surface on the elongated insulating porous film 41 side is outside. When the extension portion is wound around the outer surface of the electrode laminate 10, a restraining force caused by the extension portion is provided to the electrode laminate 10, and the positive electrode layers 20 and the negative electrode layers are less likely to be displaced.

### Experiment Examples

A conductive layer is laminated on a surface of an insulating porous film to prepare a laminate, and this laminate is used as a separator to produce a secondary battery with the conductive layer placed on a negative electrode layer side. Effects of the secondary battery will be explained with reference to Experiment Examples.

### Experiment Example 1

### (Preparation of Separator)

An insulating porous film (film thickness: 20 μm, porosity: 58%, air permeability: 92 sec/100 mL) was prepared. A copper conductive layer having a thickness of 0.08 μm was formed on one surface of the insulating porous film by an RF sputtering method. The insulating porous film having the copper conductive layer was punched out into a piece of 40 mm×50 mm size to prepare a separator.

### (Preparation of Positive Electrode Layer)

Acetylene black (AB) as an electron-conductive material, polyvinylidene fluoride (PVDF) as a binder, and polyvinylpyrrolidone (PVP) as a dispersant were premixed in N-methyl-2-pyrrolidone (NMP) as a dispersion solvent, and wet-mixed in a rotation-revolution type mixer to obtain a premixed slurry. Subsequently, Li₁Ni_{0.8}CO_{0.1}Mn_{0.1}O₂ (NCM811) as a positive electrode active material and a pre-doping material were mixed with the obtained pre-mixed slurry, and the mixture was dispersed using a planetary mixer to obtain a positive electrode active material paste. NCM811 has a median diameter of 12 μm. Next, the obtained positive electrode active material paste was applied on an aluminum positive electrode current collector having no primer layer and then dried, which was pressurized using a roll press, and dried under vacuum at 120° C. to form a positive electrode plate having a positive electrode active material layer. The resulting positive electrode plate was punched out into a piece of 30 mm×40 mm size to prepare a positive electrode layer.

### (Preparation of Negative Electrode Layer)

A copper foil (electrical conductivity: 6.5×10⁶ S/cm) having a thickness of 10 μm and a lithium foil having a thickness of 20 μm were joined to each other to prepare a clad material. This clad material was punched out into a piece of 34 mm×44 mm size to prepare a negative electrode current collector.

### (Electrolytic Solution)

In 1,2-dimethoxyethane (DME), LiFSI was dissolved at a concentration of 4 mol/L to prepare an electrolytic solution.

### (Production of Lithium Metal Secondary Battery)

The copper conductive layer of the separator was overlaid on a surface of the negative electrode current collector on the lithium foil side, and the positive electrode active material layer of the positive electrode layer was overlaid on a surface opposed to the copper conductive layer side of the separator to prepare an electrode laminate with the negative electrode layer, the separator, and the positive electrode layer, laminated in this order. Subsequently, a positive electrode terminal was attached to the positive electrode current collector of the obtained electrode laminate via a positive electrode lead wire, and a negative electrode terminal was attached to the copper foil of the negative electrode current collector via a negative electrode lead wire. The laminate attached with the positive and negative electrode terminals was put into a laminated film bag, into which the electrolytic solution was put, and the laminated film bag was sealed to produce a lithium metal secondary battery.

### Experiment Example 2

A lithium metal secondary battery was produced in the same way as in Experiment Example 1 except that a zinc conductive layer having a thickness of 0.06 μm was formed instead of the copper conductive layer by an RF sputtering method in preparation of the separator.

### Experiment Example 3

A lithium metal secondary battery was produced in the same way as in Experiment Example 1 except that a carbon nanotube (CNT) conductive layer having a thickness of 2.1 μm was formed instead of the copper conductive layer by an application method in preparation of the separator. The carbon nanotube conductive layer was formed as follows. First, carbon nanotubes were added into N-methyl-N-pyrrolidinone (NMP) as a solvent such that a solid content concentration was 4% by mass, to which PVDF (#9300, manufactured by Kureha Corporation) was added as a binder such that a proportion of PVDF was 5 parts by mass with respect to 95 parts by mass of the carbon nanotube. Subsequently, the mixture was dispersed using a rotation-revolution type mixer at 1000 rpm for 10 minutes to prepare a coating liquid. The resulting coating liquid was applied to the surface of the insulating porous film using a doctor blade and dried.

### Experiment Example 4

A lithium metal secondary battery was produced in the same way as in Experiment Example 1 except that a tin conductive layer having a thickness of 0.06 μm was formed instead of the copper conductive layer by an RF sputtering method in preparation of the separator.

### Comparative Experiment Example 1

A lithium metal secondary battery was produced in the same way as in Experiment Example 1 except that the copper conductive layer was not formed in preparation of the separator.

### Evaluation

An electrical conductivity, a surface resistivity, and a peel strength of the conductive layer of the separator prepared in each experiment example were measured by the following method. The results are presented in Table 1 together with the material, the coating method, and the thickness of the conductive layer in each separator. For each of the lithium metal secondary batteries produced in Experiment Examples and Comparative Experiment Example, the presence of short circuit was confirmed, and an increase rate of the lithium thickness was measured, according to the following method. The results are presented in Table 1.

### (Electrical Conductivity and Surface Resistivity of Conductive Layer)

The electrical conductivity and the surface resistivity were measured using a high-precision and high-performance resistivity meter (Loresta GP TCP-600, manufactured by Nittoseiko Analytech Co., Ltd.).

### (Peel Strength)

A conductive layer having a length of 5.0 cm and a width of 2.5 cm was press-bonded onto an adhesive tape having a width of 2.5 cm that had been press-bonded onto a fixed plate. Subsequently, one end of the conductive layer was folded back at 180 degrees and pulled up at a speed of 300 mm/min using an electric measurement stand (manufactured by IMADA Co., Ltd.) to peel the conductive layer from the insulating porous film. A load required for the peeling of the conductive layer from the start to the termination of the peeling was measured using a digital force gauge (manufactured by IMADA Co., Ltd.). A value determined by dividing an average value of the measured load by the width of the adhesive tape was defined as the peeling strength.

### (Confirmation of Short-Circuit in Lithium Metal Secondary Battery)

The lithium metal secondary battery immediately after produced was allowed to stand at 25° C. for 24 hours. After the standing, the lithium metal secondary battery was subjected to a first charge and discharge cycle described below 3 times, then subjected to a second charge and discharge cycle described below 50 times, and the presence of short circuit in the lithium metal secondary battery was confirmed. If the charge capacity of the lithium metal secondary battery reached 105% or higher of the discharge capacity before charging, the battery was considered to cause a short circuit, and evaluated as “Yes”.

### (First Charge and Discharge Cycle)

The charge was performed under a condition that a constant-current charge was executed at a current value of 2.2 mA and up to 4.300 V, followed by a constant-voltage charge at a voltage value of 4.300 V for 60 minutes. The discharge was performed under a condition that a constant-current discharge was executed at a current value of 4 mA and up to 2.65 V. Between the discharge and the charge, the battery was allowed to stand for 30 minutes.

### (Second Charge and Discharge Cycle)

The charge was performed under a condition that a constant-current charge was executed at a current value of 74 mA and up to 3.823 V, at a current value of 52 mA and up to 4.051 V, at a current value of 46 mA and up to 4.173 V, and at a current value of 22 mA and up to 4.300 V, and then a constant-voltage charge was executed at a voltage value of 4.300 V for 90 minutes. The discharge was performed under a condition that a constant-current discharge was executed at a current value of 18 mA and up to 2.65 V. Between the discharge and the charge, the battery was allowed to stand for 30 minutes.

### (Increase Rate of Lithium Thickness in Lithium Metal Secondary Battery)

A thickness T1 (μm) of the negative electrode layer during initial charging, and a thickness T2 (μm) of the negative electrode layer (total thickness of the negative electrode current collector and the metallic lithium layer) during charging after 50 cycles were measured, and an increase rate T (μm/cycle) of the lithium thickness was calculated from the following equation. T (μm/cycle)=(T2−T1)/50

The thickness T1 (μm) of the negative electrode layer during the initial charging was measured as follows. The lithium metal secondary battery immediately after produced was allowed to stand at 25° C. for 24 hours. After the standing, the lithium metal secondary battery was subjected to a first charge and discharge cycle described above 3 times.

Subsequently, the lithium metal secondary battery was charged by a process that a constant-current charge was executed at a current value of 14.7 mA and up to 4.300 V, followed by a constant-voltage charge at a voltage value of 4.300 V for 60 minutes. After charging, the lithium metal secondary battery was allowed to stand for 30 minutes and then disassembled, from which the negative electrode layer was taken out, and a thickness of the negative electrode layer was measured as thickness T1.

A thickness T2 of the negative electrode layer during charge after 50 cycles was measured as follows. The lithium metal secondary battery immediately after produced was allowed to stand at 25° C. for 24 hours. After the standing, the lithium metal secondary battery was subjected to the first charge and discharge cycle 3 times, and then subjected to the second charge and discharge cycle 50 times. Subsequently, the lithium metal secondary battery was charged in such a way that a constant-current charge was executed at a current value of 14.7 mA and up to 4.300 V, followed by a constant-voltage charge at a voltage value of 4.300 V for 60 minutes. After charging, the lithium metal secondary battery was allowed to stand for 30 minutes and then disassembled, from which the negative electrode layer was taken out, and a thickness of the negative electrode layer was measured as thickness T2.

TABLE 1

| | | | | | | | Evaluation result for | |
|---|---|---|---|---|---|---|---|---|
| | | | | | | | secondary battery | |
| | | | | | | | | Increase |
| | Conductive Layer | | | | | | | rate in |
| | | | | Electrical | Surface | Peel | Presence | lithium |
| | | Coating | Thickness | conductivity | resistivity | strength | of short | thickness |
| | Material | method | (μm) | (S/cm) | (Ω/cm²) | (N/m) | circuit | (μm/cycle) |
| Experiment | Cu | RF | 0.08 | 3.8 × 10⁴ | 3.5 | 260 | No | 0.42 |
| Example 1 | | sputtering | | | | | | |
| | | method | | | | | | |
| Experiment | Zn | RF | 0.06 | 3.6 × 10³ | 200 | 270 | No | 0.50 |
| Example 2 | | sputtering | | | | | | |
| | | method | | | | | | |
| Experiment | CNT | Application | 2.10 | 1.0 × 10¹ | 83 | 0.5 | No | 0.56 |
| Example 3 | | method | | | | | | |
| Experiment | Sn | RF | 0.10 | 6.3 × 10² | 190 | 270 | No | 0.52 |
| Example 4 | | sputtering | | | | | | |
| | | method | | | | | | |

| | | | |
|---|---|---|---|
| Comparative | — | Yes | 1.00 |
| Experiment | | | |
| Example 1 | | | |

As presented in Table 1, the lithium metal secondary batteries of Experiment Examples 1 to 4 including the separator having the conductive layer are less likely to cause a short circuit even through repeated charge and discharge and have a low increase rate of the lithium thickness, indicating that the metallic lithium layer (negative electrode active material layer) generated by charging is dense and has a high density. In contrast, the lithium metal secondary battery in Comparative Experiment Example 1 having the separator without the conductive layer is prone to short circuits through repeated charge and discharge and has a high increase rate of the lithium thickness, indicating that a coarse and low-density negative electrode active material layer is generated by charging.

### EXPLANATION OF REFERENCE NUMERALS

10 Electrode laminate
20 Positive electrode layer
21 Positive electrode current collector
22 Positive electrode active material layer
23 Positive electrode lead wire
24 Positive electrode terminal
30 Negative electrode layer
31 Negative electrode current collector
33 Negative electrode lead wire
34 Negative electrode terminal
40 Elongated separator
40a Extension portion
401 Conductive region
402 Nonconductive region
41 Elongated insulating porous film
41a Pore portion
42 Conductive layer
43 First fold
43a End
43b Opening
44 Second fold
44a End
44b Opening
50 Exterior body
100 Secondary battery

What is claimed is:

1. A secondary battery comprising
an electrode laminate having positive electrode layers, negative electrode layers, and a separator placed between the positive electrode layers and negative electrode layers,
an electrolytic solution,
an exterior body accommodating the electrode laminate and the electrolytic solution,
a positive electrode terminal and a negative electrode terminal provided in the exterior body,
a positive electrode lead wire electrically connecting between the positive electrode layers and the positive electrode terminal, and
a negative electrode lead wire electrically connecting between the negative electrode layers and the negative electrode terminal;
the separator having an extension portion extending outward beyond end portions of the positive electrode layers on a side connected with the positive electrode terminal; and
at least a part of a portion in contact with the negative electrode layers on a surface of the separator on the negative electrode layer side being configured as a conductive region with a conductive layer, and at least a part of an end portion of the extension portion on the positive electrode terminal side being configured as a nonconductive region without the conductive layer.

2. The secondary battery according to claim 1, wherein
the separator is an elongated separator comprising an elongated insulating porous film, the conductive region provided on one surface of the elongated insulating porous film, and the nonconductive region, the conductive region being extended along a length direction of the elongated insulating porous film, the nonconductive region being placed on at least one width-directional end portion of the elongated insulating porous film, and first folds folded along the length direction such that their surfaces on the elongated insulating porous film side are inside and second folds folded along the length direction such that their surfaces on a side of the conductive region and the nonconductive region are inside, being alternately overlaid;
the positive electrode layers are inserted into the first folds and located at a position where the nonconductive region is the extension portion, and the negative electrode layers are inserted into the second folds and located at a position in contact with the conductive region;
the positive electrode terminal is electrically connected with end portions of the positive electrode layers on the nonconductive region side; and
the negative electrode terminal is electrically connected with end portions of the negative electrode layers on an opposite side to the nonconductive region side.

3. The secondary battery according to claim 1, wherein an end portion of the conductive region on the positive electrode terminal side is located at the same position as or inside of the end portions of the negative electrode layers on the positive electrode terminal side.

4. The secondary battery according to claim 1, wherein the nonconductive region is located only on the end portion of the separator on the positive electrode terminal side.

5. The secondary battery according to claim 1, wherein a negative electrode active material is metallic lithium.

6. A production method for a secondary battery, comprising:
Preparing an elongated separator by folding, in a zigzag shape, an elongated laminated sheet comprising an elongated insulating porous film, a conductive region with a conductive layer placed on one surface of the elongated insulating porous film, and a nonconductive region without the conductive layer, the conductive region being extended along a length direction of the elongated insulating porous film, and the nonconductive region being placed on at least one width-directional end portion of the elongated insulating porous film, in such a way that first folds folded along the length direction such that their surfaces on the elongated insulating porous film side are inside and second folds folded along the length direction such that their surfaces on a side of the conductive region and the nonconductive region are inside, being alternately overlaid;
placing positive electrode layers and negative electrode layers in the first folds and the second folds respectively so as to be opposed to each other; and
connecting a positive electrode terminal to end portions of the positive electrode layers on the nonconductive region side via a positive electrode lead wire, and connecting a negative electrode terminal to end portions of the negative electrode layers on an opposite side to a side connected with the positive electrode terminal via a negative electrode lead wire.
